(19) United States
(12) Patent Application Publication
(10) Pub. No.: US 2023/0298045 A1
(43) Pub. Date: Sep. 21, 2023

(54) FOOD AUTHENTICATION SYSTEM AND FOOD AUTHENTICATION METHOD

(71) Applicant: Hitachi, Ltd., Tokyo (JP)

(72) Inventors: Kenji KOGO, Tokyo (JP); Naohiro KOHMU, Tokyo (JP); Akira KITAYAMA, Tokyo (JP); Goichi ONO, Tokyo (JP)

(21) Appl. No.: 18/080,880

(22) Filed: Dec. 14, 2022

(30) Foreign Application Priority Data
Mar. 16, 2022 (JP) 2022-041942

(51) Int. Cl. G06Q 30/018

(52) U.S. Cl. CPC G06Q 30/018

(57) ABSTRACT

Provided is a new technique that enables authentication of sources as well as storage and distribution conditions of food. A preferred aspect of the invention is a food authentication method to be executed by an information processing apparatus including a processor, a memory, an input and output apparatus, and a storage apparatus, the food authentication method including: a first step of setting unique information of food measured at a first time as a unique information initial value; a second step of acquiring environmental information that is associated with the food and that is measured at a second time after the first time; a third step of setting unique information of the food measured at a third time after the second time as a unique information measurement value; a fourth step of calculating a prediction value of the unique information based on the unique information initial value and the environmental information and setting the prediction value as a unique information prediction value; and a fifth step of performing authentication of the food based on the unique information measurement value and the unique information prediction value.

### BACKGROUND OF THE INVENTION

### 1. Field of the Invention

The present invention relates to a technique for managing product quality, particularly food quality.

### 2. Description of the Related Art

Competition between production areas and international competition for agricultural products has intensified, and it has become important to improve additional value of the agricultural products. For this reason, trend of making the agricultural products or the like brand in the production areas or the like is accelerating. On the other hand, a disguise in the production areas of the agricultural products or the like, replacement of products in a distribution channel, and the like have become serious problems.

However, it is difficult for a general consumer who is not a producer or a skilled seller to judge quality of branded agricultural, forest and fishery products without brand indications such as trademarks.

In addition, for the agricultural, forest and fishery products, storage management at each stage of production, processing and distribution has a great influence on quality. Due to such recent circumstances, consumers are becoming more and more interested in “roots of food”, which includes the production, processing, and distribution of food. In order to meet such consumer needs, clarification and transparency of a standard of food distribution are important in the future, and there will be a demand for secure and safe food with transparency in sources and distribution channels of food.

Further, assurance of quality such as aroma and taste is an important factor for food, and there are agricultural products graded according to quality. In this regard, it is difficult for a general consumer who is not a producer or a skilled seller to judge such quality. In addition, in terms of grading of wagyu beef or the like, it has been criticized and pointed out that human judgment lacks scientific basis, and interest in food measurement is increasing from a viewpoint of quality assurance.

For example, JP-A-2006-146570 discloses an individual authentication and trace system capable of tracing harvested agricultural products by using field server groups disposed to collect and monitor meteorological observation and cultivating environment data in a plurality of points of cultivating agricultural products in a cultivating ground management field and capable of checking that the harvested agricultural products are the same as purchased agricultural products.

JP-A-2018-203414 discloses that a control schedule in which a specific delivery facility controls a parameter is calculated from product management information and a delivery time of a specific product, and that when the product is a vegetable or a fruit, a parameter indicating a growth or ripening state can be used as the parameter.

After a specific food is produced, it is necessary to prevent the disguise such as replacement in storage and distribution channels.

In a technique of JP-A-2006-146570, along with an attached identifier such as a radio frequency identifier (RF-ID), biological information of an object is used as a pair of information for authentication. Since the biological information can also be used as a fraud measure if the same hard copy or information as that of the object is created, a change record of the biological information is accumulated as time series information by utilizing a fact that the biological information changes little by little over time, and the fraud is detected.

However, in JP-A-2006-146570, image information obtained by a camera is used as the biological information. Authentication using only the camera is complicated because the authentication requires adjustment of surrounding brightness and a degree of exposure to light at the time of imaging. In addition, although movement and identity of agricultural products are verified by going back in time and location, it is difficult to deal with a sudden change in appearance, damage during transportation, or the like.

In addition, it is necessary to check, with high frequency, fruits and vegetables such as ripening fruits (banana, kiwi fruit, etc.) that require time for storage and transportation from a producer to a store, and fruits and vegetables whose appearance changes rapidly, such as strawberries and leafy vegetables, etc., which causes an increase in cost.

In addition, it cannot deal with changes in taste and smell, which are important parameters in food quality but cannot be judged by appearance.

JP-A-2018-203414 discloses that a period from production to delivery of a product can be shortened by calculating a control schedule and a delivery schedule of a delivery facility from a delivery time, a state of the product at the time of shipment, and a state requested by a destination, and exemplifies sugar content and odor as parameters to be controlled.

However, in JP-A-2018-203414, it is not considered to guarantee whether individual products are the same at the time of shipment and at the time of arrival.

### SUMMARY OF THE INVENTION

Therefore, an object of the invention is to provide a new technique that enables authentication of sources as well as storage and distribution conditions of food.

A preferred aspect of the invention a food authentication method to be executed by an information processing apparatus including a processor, a memory, an input and output apparatus, and a storage apparatus, the food authentication method including: a first step of setting unique information of food measured at a first time as a unique information initial value; a second step of acquiring environmental information that is associated with the food and that is measured at a second time after the first time; a third step of setting unique information of the food measured at a third time after the second time as a unique information measurement value; a fourth step of calculating a prediction value of the unique information based on the unique information initial value and the environmental information and setting the prediction value as a unique information prediction value; and a fifth step of performing authentication of the food based on the unique information measurement value and the unique information prediction value.

Another preferred aspect of the invention is a food authentication system, including: a processor; a memory; an input and output apparatus; a storage apparatus; a unique information prediction unit; and an authentication unit, in which the unique information prediction unit is configured to: receive unique information of food measured at a first time as a unique information initial value; receive environmental information that is associated with the food and that is measured at a second time after the first time; and calculate a prediction value of the unique information based on the unique information initial value and the environmental information, and set the prediction value as unique information prediction value, and the authentication unit is configured to: receive unique information of the food measured at a third time after the second time as a unique information measurement value; and perform authentication of the food based on the unique information measurement value and the unique information prediction value.

It is possible to provide a new technique that enables authentication of sources as well as storage and distribution conditions of food.

### BRIEF DESCRIPTION OF THE DRAWINGS

FIG. 1 conceptual diagram showing a food authentication system according to an embodiment.

FIG. 2 is an overall block diagram of a food authentication system 1 according to the embodiment.

FIG. 3 is a table showing an example of identification information 31.

FIG. 4 is a table showing an example of unique information initial values 32.

FIG. 5 is a table showing an example of environmental information 33.

FIG. 6 is a block diagram showing a hardware configuration of an authentication server 100.

FIG. 7 is a flowchart showing a food authentication process when one food 20 is distributed from a producer to a seller.

FIG. 8 is a flowchart showing details of an authentication process S710 of an authentication unit 60.

FIG. 9 is a conceptual diagram showing a process in which a unique information prediction unit 50 predicts unique information from the a unique information initial values 32 and the environmental information 33.

FIG. 10 is a conceptual diagram showing an example in which principal component analysis is performed in a feature data analysis unit 1001 and two principal components are extracted.

FIG. 11 is a graph showing a principle of authentication performed by comparing Euclidean distance between two principal components.

### DESCRIPTION OF THE PREFERRED EMBODIMENTS

Hereinafter, embodiments of the invention will be described with reference to the drawings. The embodiments are examples for describing the invention, and omission and simplification are appropriately made for clarified description. The invention can be implemented in various other forms. Unless otherwise specified, each component may be singular or plural.

In order to facilitate understanding of the invention, a position, a size, a shape, a range, or the like of each component shown in the drawings may not represent an actual position, size, shape, range, or the like. Therefore, the invention is not necessarily limited to the position, size, shape, range, or the like shown in the drawings.

Examples of various types of information may described by expressions such as “table”, “list”, and “queue”, but the various types of information may be expressed by a data structure other than these expressions. For example, the various types of information such as “XX table”, “XX list”, and “XX queue” may be “XX information”. When identification information is described, expressions such as “identification information”, “identifier”, “name”, “ID”, and “number” are used, but these expressions may be replaced with each other.

When there are a plurality of components having the same or similar functions, different subscripts may be added to the same reference numeral. When it is not necessary to distinguish the plurality of components from one another, the subscripts may be omitted in the description.

In the embodiments, a process performed by executing a program may be described. Here, a computer executes the program by a processor (for example, a central processing unit (CPU)), and performs the process defined by the program using a storage resource (for example, a memory), an interface device (for example, a communication port), or the like. Therefore, a subject of the process performed by executing the program may be the processor. Similarly, a subject of the process executed by executing a program may be a controller, an apparatus, a system, a computer, or a node which includes a processor. The subject of the process performed by executing the program may be a calculation unit and may include a dedicated circuit that performs a specific process. Here, the dedicated circuit is, for example, a field programmable gate array (FPGA), an application specific integrated circuit (ASIC), a complex programmable logic device (CPLD), or the like.

A program may be installed on a computer from a program source. The program source may be, for example, a program distribution server or a storage medium readable by a computer. When the program source is the program distribution server, the program distribution server may include the processor and the storage resource that stores a program to be distributed, and the processor of the program distribution server may distribute the program to be distributed to another computer. In addition, in the embodiments, two or more programs may be implemented as one program, or one program may be implemented as two or more programs.

In a food authentication system according to the present embodiments, an identifier (tag) is associated with unique information of fruits and vegetables at stages of production and shipment. Since the unique information such as taste and aroma changes with time, environmental information during transportation and storage is constantly or periodically acquired, and the unique information predicted based on the environmental information and unique information of an entity in a store are authenticated.

In addition, fruits and vegetables vary greatly among individuals, and it difficult to ensure sufficient authentication accuracy using only one piece of unique information. Therefore, the authentication accuracy is improved by feature data analysis using a plurality of pieces of unique information and the environmental information during transportation.

In an authentication method according to the present embodiments, since authentication is performed using a method other than appearance, robust authentication can be performed.

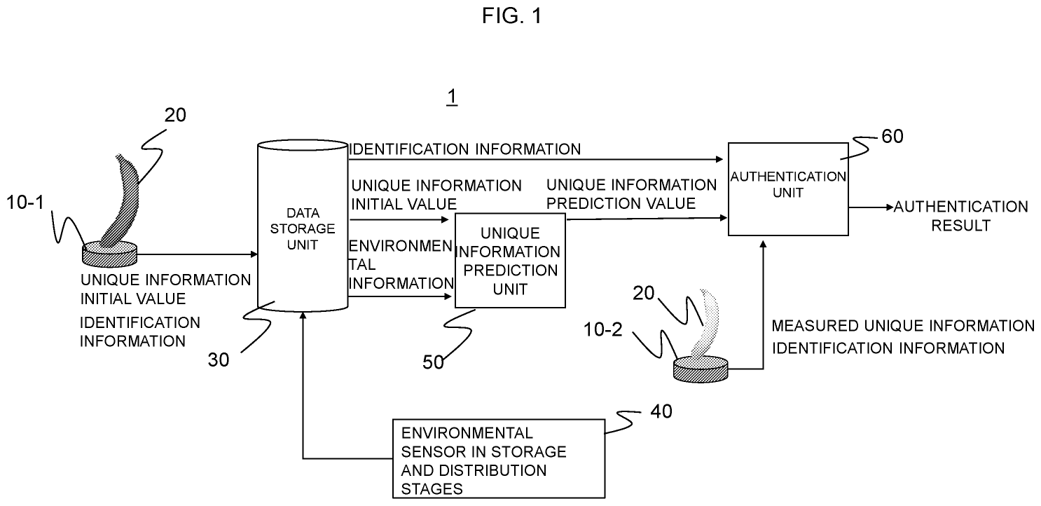

FIG. 1 is a conceptual diagram showing the food authentication system according to the embodiment.

In a food authentication system 1 according to the embodiment, unique information of food 20 is measured by a unique information measurement device 10-1 at a predetermined time such as production or shipment. Hereinafter, the measured unique information is referred to as a “unique information initial value”. In this example, the food is a fruit (for example, banana). The invention can be applied not only to fruits but also to food whose unique information changes with time, such as alcoholic beverages and meat-processed products.

The unique information is not limited as long as it is a value related to food quality, such as appearance, sugar content, acidity, alcohol content, odor, weight, hardness, a moisture amount, an odor component amount, a volatile component amount, and a contained component amount. In the present embodiment, the authentication can also be performed by using unique information other than the appearance. As the unique information measurement device 10, a known apparatus capable of non-invasively measuring such unique information is used.

In addition, identification information such as a bar code and an RF-ID (not shown) is attached to the food 20. The bar code and the RF-ID have information capable of uniquely identifying a product, and are added to the food 20 itself, packaging of a product, or the like.

The measured unique information initial value is associated with the attached identification information and recorded in a data storage unit (database) 30.

For the food 20, temporal change information of the environmental information is acquired at each stage of storage and distribution after the unique information initial value is measured. For this purpose, an environment sensor 40 in storage and distribution stages is installed in a storage location and a delivery facility of the food 20, and acquires the environmental information.

The environmental information includes, for example, temperature, humidity, a light amount, a gas concentration (for example, ethylene gas, carbon dioxide, and methane), a vibration amount (acceleration), and the like. As the environment sensor 40 in the storage and distribution stages, a known apparatus capable of acquiring such environmental information is used. The environmental information is acquired as time series data. A frequency of acquisition may be freely set in accordance with properties as well as states of storage and distribution of the food.

Which storage location the specific food 20 is stored and which delivery facility the specific food 20 is distributed in is stored in a data storage unit 30 as product management information that directly or indirectly associates the identification information of the food 20 with identification information of the environment sensor 40 disposed in the storage location and the delivery facility. With this configuration, the identification information of the food 20 can be associated with data obtained from an environment sensor.

The data storage unit 30 stores the temporal change information (hereinafter, referred to as “environmental information”) of the environmental information of the storage and distribution stages of the food 20 measured by the environment sensor 40.

The fruit (for example, banana) is ripened at the time of distribution, and for example, the sugar content changes, but ripening is affected by the temperature and the humidity at the time of storage and distribution, that is, the environmental information.

The food authentication system 1 according to the present embodiment includes a unique information prediction unit 50 that predicts (estimates) unique information at a predetermined time (for example, at the time of arrival or use of a product) using the unique information initial value and the environmental information as inputs. The predicted unique information is referred to as a “unique information prediction value”.

As the unique information prediction unit 50 for prediction, a simulator or an estimation model obtained by machine learning using actual measurement data as training data can be used.

At the predetermined time, the unique information of the food 20 is measured again by a unique information measurement device 10-2. Then, the unique information measured together with the identification information is sent to an authentication unit 60 and compared with the unique information prediction value. When a difference between the measured unique information and the unique information prediction value is within a predetermined range, it can be authenticated that the food 20 whose unique information initial value is measured has been distributed in the storage location and the delivery facility defined in the product management information associated with the identification information of the food 20 in advance.

If the difference between the unique information and the unique information prediction value deviates from the predetermined range, the product itself may have been. replaced or may have been provided under conditions other than planned storage and distribution conditions.

As described above, the food authentication system according to the present embodiment enables authentication of sources as well as the storage and distribution conditions that do not depend on the appearance of the food.

### Embodiment 1

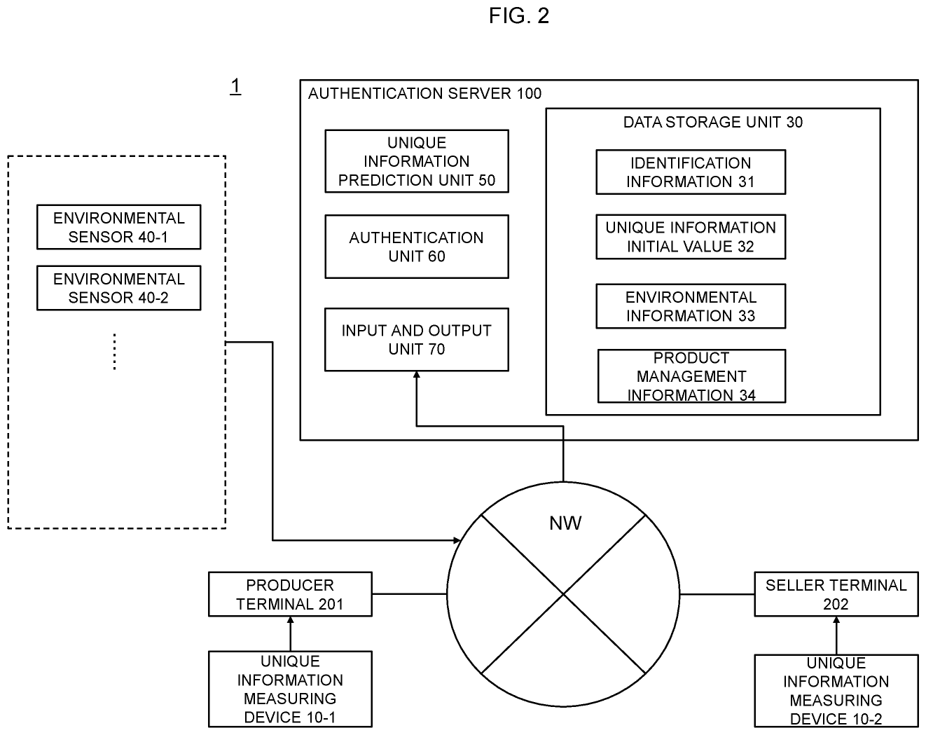

FIG. 2 is an overall block diagram of the food authentication system 1 according to the embodiment. In this example, the food authentication system includes a plurality of information processing apparatuses and sensors connected via any network NW.

An authentication server 100 includes the data storage unit 30, the unique information prediction unit 50, the authentication unit 60, and an input and output unit 70. As will be described later, the authentication server 100 is configured with a general computer, and various functions are implemented by software.

The data storage unit 30 is configured with, for example, a magnetic disk apparatus. Although the data storage unit 30 is a part of the authentication server 100 in FIG. 2, the data storage unit 30 may be configured with another apparatus connected via the network NW. The data storage unit 30 stores identification information 31, a unique information intial value 32, environmental information 33, and product management information 34.

A producer terminal 201 is, for example, at start of a distribution channel of the food 20, acquires the unique information initial value of the food 20 using the unique information measurement device 10-1, transmits the unique information initial value to the authentication server 100 via the network NW, and registers the unique information initial value in the data storage unit 30. A specific example of the producer terminal 201 is a terminal managed by a producer or a shipper of the food 20.

A seller terminal 202 is, for example, at an end of the distribution channel of the food 20, acquires the unique information of the food 20 using the unique information measurement device 10-2, transmits the unique information to the authentication server 100 via the network NW, and compares the unique information with the unique information initial value in the authentication unit 60. A specific example is a terminal managed by a seller of the food 20.

The producer terminal 201 and the seller terminal 202 can be configured with an information processing apparatus such as a normal personal computer, and require a function of receiving data measured by the unique information measurement device 10 and transmitting the data to the authentication server 100 via the network NW. A plurality of sets of the producer terminal 201 and the seller terminal 202 may exist corresponding to a plurality of products and a plurality of distribution channels.

The environment sensor 40 is disposed in the storage location or the distribution channel of the food 20, acquires various types of environmental information, and transmits the acquired environmental information to the authentication server 100 via the network NW. There may be a plurality of types, numbers, and installation locations of the environment sensors 40.

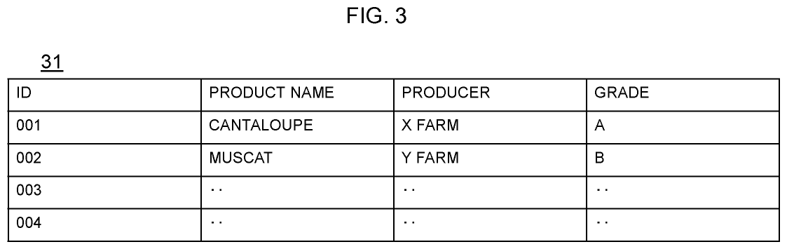

FIG. 3 is a table showing an example of the identification information 31. An ID uniquely indicating the food 20 and other information such as a product name, a producer, and a grade corresponding to the ID are stored. The example of FIG. 3 is an example, and other information may be stored. The ID corresponds to information such as the bar code or the RF-ID attached to the food 20. As the identification information 31, a system administrator registers data in advance. Alternatively, data can be transmitted from the producer terminal 201. When data is transmitted from the producer terminal 201, each producer can register own data in the authentication server 100.

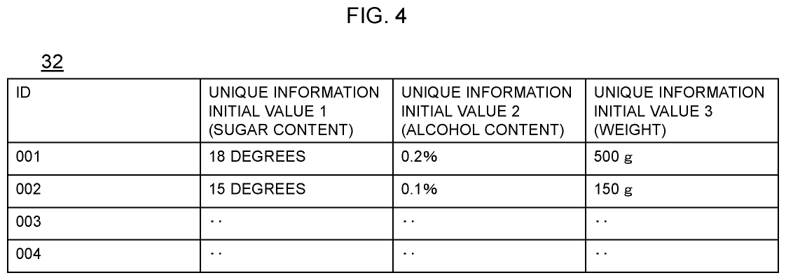

FIG. 4 is a table showing an example of the unique information initial values 32. Data of unique information initial values is stored corresponding to the ID uniquely indicating the food 20. In the example of FIG. 4, values of sugar content, alcohol content, and weight are recorded. This is an example, and unique information corresponding to other types of the unique information measurement device 10 may be stored. The ID corresponds to the identification information such as the bar code or the RF-ID attached to the food 20, and corresponds to the ID of the identification information 31. The unique information initial value 32 transmits data from the producer terminal 201.

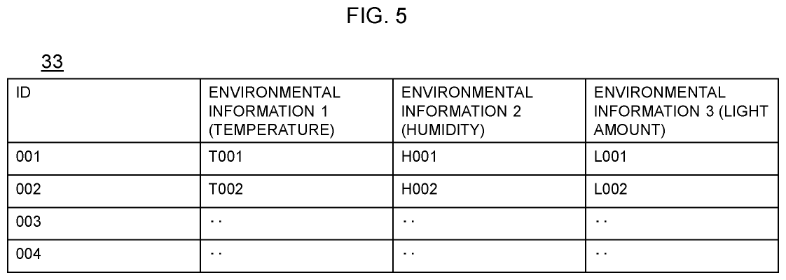

FIG. 5 is a table showing an example of the environmental information 33. Data of environmental information is stored corresponding to the ID uniquely indicating the food 20. In the example of FIG. 5, time series data of the temperature, the humidity, and the light amount is recorded. In FIG. 5, each time series data is indicated by a code, and is configured to be able to call the corresponding data. This is an example, and environmental information corresponding to other types of the environment sensors 40 may be stored. The ID corresponds to the identification information such as the bar code or the RF-ID attached to the food 20, and corresponds to the ID of the identification information 31. The environmental information 33 is recorded in the data storage unit 30 by transmitting data from the environment sensors 40 disposed in the storage and distribution channels of the product to the authentication server 100.

Although not shown, the product management information 34 stores data for associating the ID of the identification information 31 with the environment sensors 40 as described above. Therefore, the ID of the identification information. 31 may be directly associated with the environment sensors 40, or the ID of the identification information 31 may be associated with ID of the storage and distribution channels of the product, and further the ID of the storage and distribution channels may be associated with the ID of the environment sensors 40. In any case, the ID uniquely indicating the food 20 may be associated with the data of the environmental information.

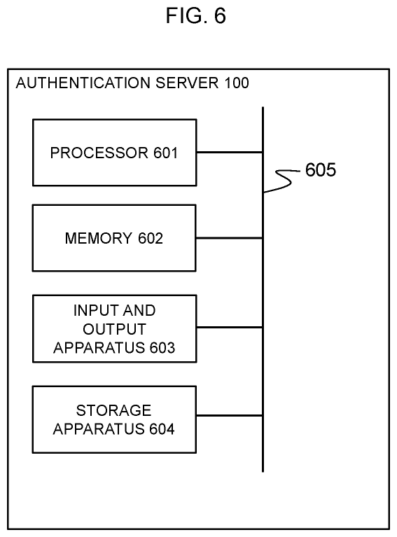

FIG. 6 is a block diagram showing a hardware configuration of the authentication server 100. A general server configuration includes a processor 601, a memory 602 such as a semiconductor memory, an input and output apparatus 603 that performs input and output, and a storage apparatus 604 such as a magnetic disk apparatus. These components are connected by a bus 605.

Corresponding to FIG. 2, the data storage unit 30 is implemented by the storage apparatus 604, and the unique information prediction unit 50, the authentication unit 60, and the input and output unit 70 are implemented by the processor 601 executing software stored in the memory 602 and cooperating with the other hardware.

The input and output unit 70 uses the input and output apparatus 603 to input various types of data input via the network NW or the like to the data storage unit 30. In addition, the input and output unit 70 outputs data from the data storage unit 30 via the network NW or the like. The input and output unit 70 uses the input and output apparatus 603 to receive a request or the like to the authentication server 100, or outputs information in response to the request from the authentication server 100. The input and output apparatus 603 includes a network interface, and various generally known apparatuses may be used as the input and output apparatus 603.

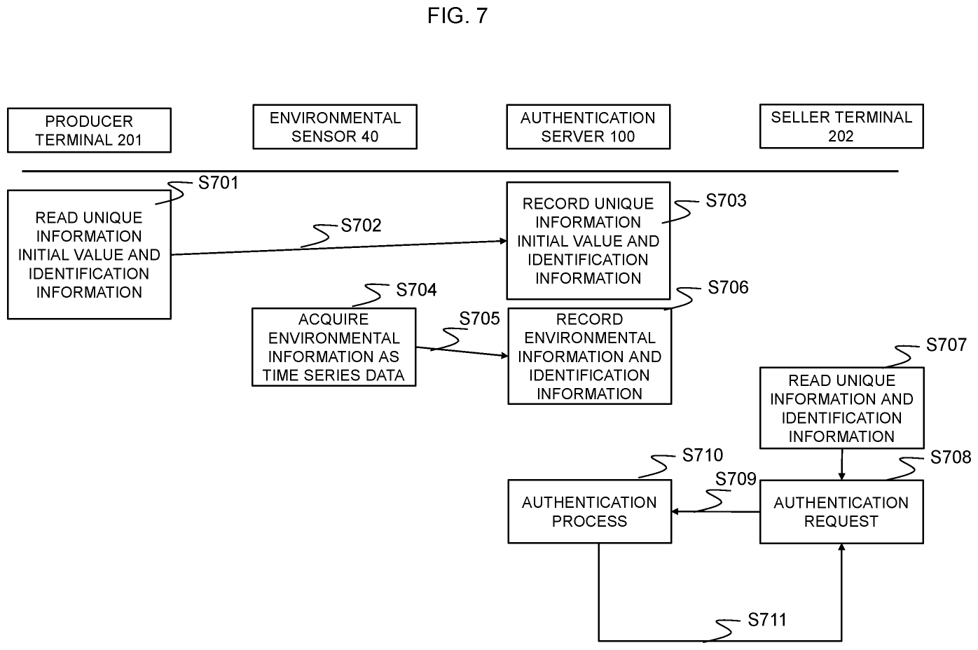

FIG. 7 is a flowchart showing a food authentication process when one food 20 is distributed from a producer (start of distribution) to a seller (end of distribution) in the food authentication system 1 according to the embodiment.

Process S701 is a process at the start of the distribution channel. In process S701, the producer terminal 201 reads the unique information initial value of the food 20 using the unique information measurement device 10-1. In addition, the producer terminal 201 reads identification information corresponding to the food 20 by a known technique. For example, identification information is read from the RF-ID attached to the food 20. Alternatively, the bar code from which data has been acquired is attached to the food 20. It is desirable that the unique information measurement device 10-1 measures a plurality of types of unique information.

In process S702, the producer terminal 201 makes the unique information initial value and the identification information into a set, and transmits the set of the unique information initial value and the identification information to the authentication server 100 via the network NW or the like. At this time, other data may be transmitted in association with the identification information.

In process S703, the input and output unit 70 of the authentication server 100 records the unique information initial value and the identification information received from the producer terminal 201 in the data storage unit 30. In the present embodiment, although the unique information initial value 32 (FIG. 4) and the identification information 31 (FIG. 3) are independent data tables, it is needless to say that the unique information initial value 32 and the identification information 31 may be one table or separated into three or more tables as long as the unique information initial value 32 and the identification information 31 can be referred to each other by specifying the identification. information.

In process S704, the environment sensors 40 disposed in the storage and distribution channels of the food 20 acquire the environmental information as time series data. In general, there are a plurality of environment sensors 40, which measure environmental information at different times, respectively.

In process S705, the environment sensors 40 transmit the environmental information to the authentication server 100. As a specific example, an example will be described in which fruits and vegetables to which an RF-ID is attached are assumed as the food 20, and temperature data is acquired as the environmental information. Each of the environment sensors 40 can cooperate with an RF-ID reader that reads identification information from the RF-ID. Each of the environment sensors 40 is directly or indirectly connected to the network NW, and can communicate with the authentication server 100.

For example, when fruits and vegetables are stored in a warehouse as a storage location, identification information is read from RF-IDs attached to the fruits and vegetables when the fruits and vegetables are delivered to the warehouse, and the read time is recorded as a delivery time together with the identification information. In addition, identification information is read from the RF-IDs attached to the fruits and vegetables when the fruits and vegetables are shipped from the warehouse, and the read recorded as a shipment time together with the identification information.

Temperature data is acquired at a predetermined frequency by the environment sensors 40 provided in a warehouse. Each of the environment sensors 40 makes the temperature data and a measurement time into a set, records the temperature data from the delivery time to the shipment time as time series data, and transmits the temperature data to the authentication server 100 via the network NW together with the identification information.

When the food 20 is transported by a truck or a ship, the environmental information can be acquired and transmitted by the same process as described above. The transmission of data may be performed in real time via a network, or time series data accumulated for a predetermined period may be downloaded and transmitted at any time.

In the above example, since the environment sensors 40 are disposed in various locations of the storage location and a transportation facility, and the environmental information is read in association with the identification information of the product, time series data from the start to the end of the distribution channel can be obtained by integrating data from the plurality of environment sensors. In this example, the product management information 34 may not be used.

When the environmental information is not associated with the identification information of the product, the environmental information may be transmitted to the authentication server 100 in association with the identification information of the environment sensors 40, and the environmental information may be associated with the identification information of the food 20 based on the product management information 34.

If the environment sensor 40 can be configured to be small in size, the environment sensor 40 can be incorporated in packaging or a container of the food 20, so that the time series data from the start to the end of the distribution channel can be acquired by a single environment sensor.

In process S706, the input and output unit 70 of the authentication server 100 records the environmental information in the data storage unit 30. In the present embodiment, the environmental information 33 is in a format of specifying the environmental information using a code and calling the time series data (FIG. 5), but the format of the data is not limited to this.

Process S707 is a process at the end of the distribution channel. In process S707, the seller terminal 202 reads the unique information of the food 20 using the unique information measurement device 10-2. In addition, the producer terminal 201 reads identification information corresponding to the food 20 by a known technique. For example, the identification information is read from the RF-ID attached to the food 20.

In process S708, the seller terminal 202 transmits, to the authentication server 100, an authentication request for authenticating whether the food 20 is a product certainly provided at the start of the distribution channel, together with the unique information and the identification information of the food 20 read in process S707. For example, process S708 is executed by a user such as a seller performing a predetermined input on the seller terminal 202.

In process S709, based on the authentication request, the seller terminal 202 transmits an authentication request command to the authentication server 100 via the network NW together with the unique information and the identification information of the food 20.

In process S710, the input and output unit 70 of the authentication server 100 receives the authentication. request command, and the authentication unit 60 executes an authentication process. Details will be described later. After the authentication process, the input and output unit 70 of the authentication server 100 transmits an authentication result output by the authentication unit 60 to the seller terminal 202 via the network NW.

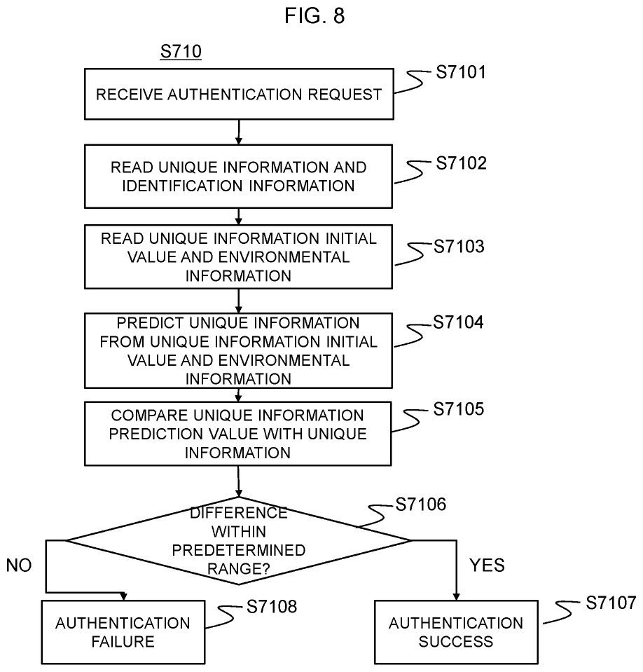

FIG. 8 is a flowchart showing details of the authentication process S710 of the authentication unit 60.

In process S7101, the input and output unit 70 of the authentication server 100 receives the authentication request command from the seller terminal 202 and instructs the authentication unit 60 to perform the authentication process.

In process S7102, the authentication unit 60 reads the unique information and the identification information of the food 20 transmitted from the seller terminal 202.

In process S7103, the authentication unit 60 searches for the unique information initial value 32 and the environmental information 33 of the data storage unit 30 using the identification information read in process S7102, and reads unique information initial values and environmental information associated with the corresponding identification information.

In process S7104, the authentication unit 60 inputs the unique information initial value 32 and the environmental information 33 to the unique information prediction unit 50, and obtains a prediction value of the unique information (unique information prediction value). The unique information prediction value is, for example, a prediction value of the unique information at the time of arrival at the end of the distribution channel.

In process S7105, the authentication unit 60 compares the unique information of the food 20 transmitted from the seller terminal 202 will the unique information prediction value predicted by the unique information prediction unit 50.

In process S7106, if the result of the comparison in process S7105 is within a predetermined range, the authentication unit 60 determines that the food 20 is the product certainly provided at the start of the distribution channel and succeeds in authentication, and transmits the authentication result to the seller terminal 202 via the input and output unit 70.

When the result of the comparison in the process S7105 is out of the predetermined range, there is a possibility that the product is not the one whose unique information initial value is read in process S701, and that the product is not the one whose environmental information is acquired in the process S704. In any case, a product shipped by a producer does not reach a seller through a correct channel.

In process S7107, if the result of the comparison in the process S7105 is not within the predetermined range, the authentication unit 60 determines that the authentication is failed and transmits the result to the seller terminal 202 via the input and output unit 70.

According to the present embodiment, for example, when identification information including an RF-ID or a bar code is attached to another product in the middle of the distribution channel, the replacement can be detected by comparing the unique information with the unique information prediction value.

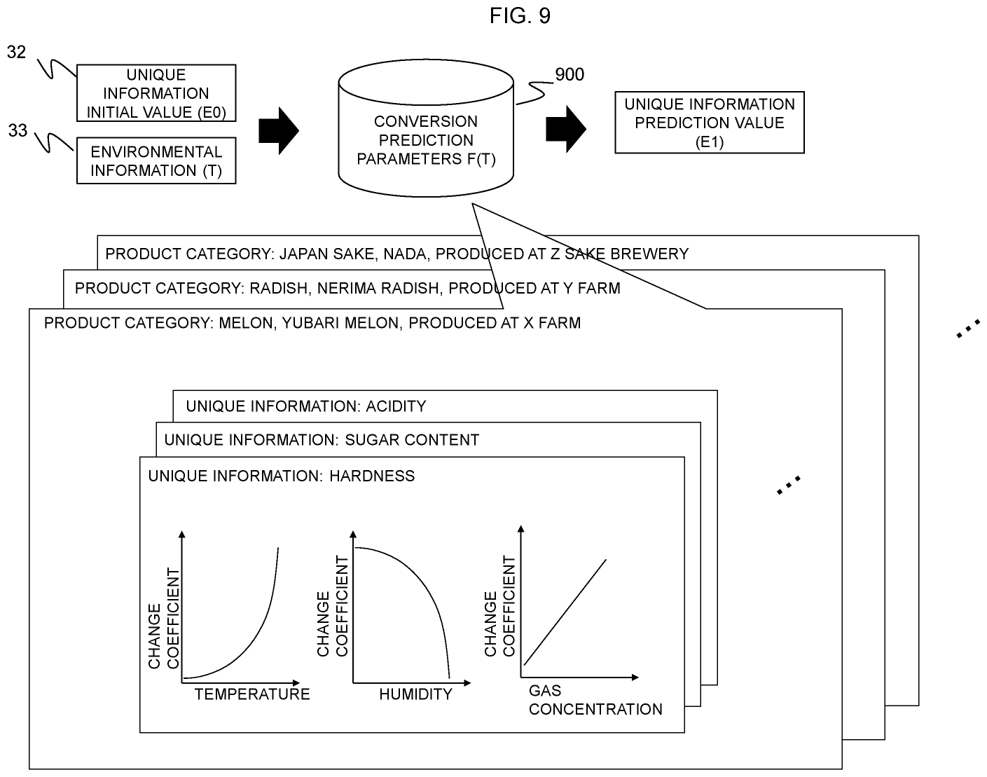

FIG. 9 is a conceptual diagram showing a process in which the unique information prediction unit 50 predicts the unique information from the unique information initial values 32 and the environmental information 33.

The unique information prediction unit 50 functionally performs following input and output.

Input: unique information initial value (E0), environmental information (T)

Output: unique information prediction value (E1)

Calculation in the unique information prediction unit 50 can be simplified, for example, as E0×f(T)=E1.

Here, f(T) is a conversion prediction parameter. The conversion prediction parameters 900 represent change rates of predetermined unique information (for example, the hardness, the sugar content, the acidity, and the like) with respect to predetermined environmental information (for example, the temperature, the humidity, and the gas concentration).

The conversion prediction parameters are actually measured as follows and stored in advance in the unique information prediction unit 50. That is, since the food 20 to be authenticated is determined in advance, temporal changes in the predetermined unique information (for example, hardness) are measured under a constant environmental condition (for example, constant temperature) for each product category (for example, type, brand, production area, or the like) of product samples to be predicted, and conversion prediction parameters of the unique information with respect to the environmental information in the product category are obtained.

Accuracy may be improved by measuring a plurality of pieces of data using the food 20 of the same product category as a plurality of samples and taking an average value. The determined conversion prediction parameters are stored in a database of the unique information prediction unit 50 in association with the product category and unique information.

In a database of FIG. 9, as an example, conversion prediction parameters for a product of a product category “melon, Yubari melon, produced at X farm.” are stored. The conversion prediction parameters are stored for each unique information such as the hardness, the sugar content, and the acidity, and for each environmental information such as the temperature, the humidity, and the gas concentration. In an actual database, similar data is stored for a plurality of product categories.

Since the conversion parameters of eigenvalues vary depending on environmental conditions (e.g., the temperature, the humidity, and the gas concentration), it is desirable to create the conversion parameters under many environmental conditions. When it is desired to avoid a burden of preparation under a large number of environmental conditions, the conversion parameters are measured under a few conditions changed from reference environmental conditions, and differences are corrected as coefficients, for example. The conversion parameters can be extended by storing the coefficients as approximate expressions and complementing unmeasured environmental conditions.

A graph of the conversion parameters shown in FIG. 9 indicates change coefficients with respect to the environmental conditions. In general, since the environmental conditions that are time series information vary with time, in calculation of the unique information prediction value, changes in the unique information may be calculated for each predetermined period in which the environmental conditions can be regarded as constant, and may be finally added.

Although the above is an example in which the unique information prediction unit 50 is configured by preparing the conversion parameters based on actual measurement values, when big data can be used, the unique information prediction unit 50 may be constructed by supervised learning of an inference model using the unique information initial value (E0) and the environmental information (I) as explanatory variables (input) and using the unique information prediction value (E1) as an objective variable (output).

### Embodiment 2

An example will be described in which, when the authentication unit 60 compares the unique information prediction value with the measured unique information, a plurality of types of unique information are comprehensively compared with each other, thereby enabling accurate prediction.

Although improvement in prediction accuracy can be expected by considering a plurality of types of the unique information, a large number of dimensions in a data set increases processing load. Therefore, it is conceivable to perform dimension reduction by adopting principal component analysis (PCA) which is a known method.

In the principal component analysis, feature data in the data set can be reduced by extracting the feature data, and visualization of tie data becomes easy.

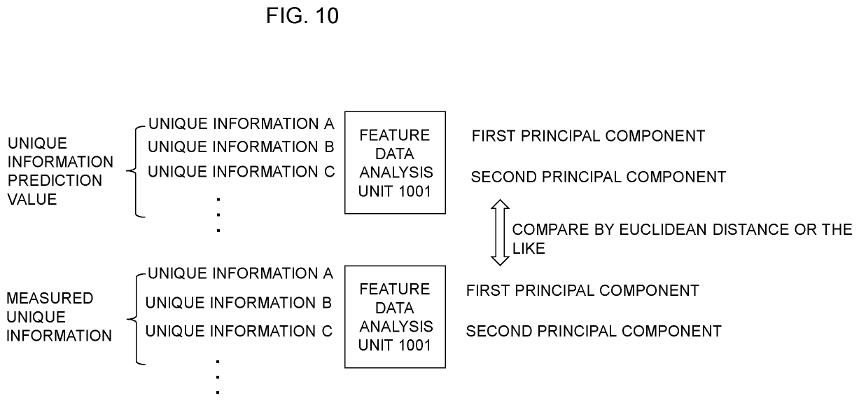

FIG. 10 is a conceptual diagram showing an example in which the authentication unit 60 performs the principal component analysis on both the unique information prediction value and the measured unique information in a feature data analysis unit 1001 provided in (or separately from) the authentication unit 60 and extracts two principal components. After the principal components are extracted, the two principal components of the prediction value and the measurement value are compared by, for example, calculating Euclidean distance.

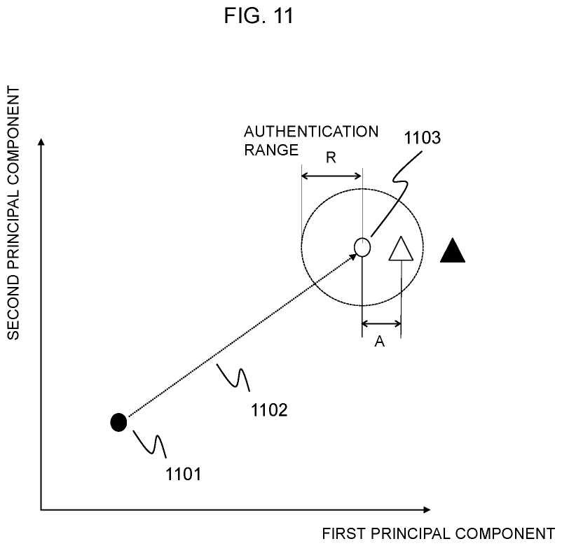

FIG. 11 is a diagram showing a principle in which the authentication unit 60 performs authentication by comparing Euclidean distance between two principal components obtained from both the unique information prediction value and the measured unique information. Such a diagram can also be displayed as a graphical user interface (GUI) on an output apparatus.

Here, two principal components are extracted from a plurality of types of unique information and displayed on two-dimensional coordinates. A principal component 1101 obtained from the unique information initial value is indicated by a black circle. An arrow 1102 indicates a predicted change that an environmental condition at the time of distribution of a product affects the principal component of the unique information of the product. A principal component 1103 obtained from the unique information prediction value is indicated by a white circle.

In the authentication, when the principal component of the measured unique information is within a range of a Euclidean distance R from the principal component 1103 obtained from the unique information prediction value, it is determined that the authentication is successful.

As a specific example, the principal component 1101 of the unique information at the time of product shipment and the principal component 1103 of the unique information predicted from the environmental condition are set as correct values, and R or less in the Euclidean distance from the correct values is set as the range of authentication success.

For example, if Euclidean distance A of a measurement result of unique information and a unique information prediction value in a retail and sales stage satisfies A≤R, the authentication is successful (white triangle mark), and if Euclidean distance A satisfies A>R, the authentication is failed (black triangle mark).

### Embodiment 3

When storage and distribution channels of a product are multi-tiered, for example, when the product is shipped from a warehouse to a truck, is reloaded from the truck to a train at a station, is reloaded from the train to a ship at a wharf, and is exported from the ship, the authentication may be performed a plurality of times for each site (e.g., the warehouse, the station, and the wharf).

In this case, when the authentication is successful at each site, the unique information initial value 32 of a database can be updated to actually measured unique information after the authentication. With this configuration, even a product having a long distribution channel can be authenticated accurately as a whole,

According to the above embodiments, even if the unique information is not necessarily acquired at a high frequency, unique information at the time of arrival can be estimated and authenticated by prediction using environmental information. Since efficient economic activity can be implemented, it is possible to reduce energy consumption and carbon emissions, prevent global warming, and contribute to implementation of sustainable society.

What is claimed is:

1. A food authentication method to be executed by an information processing apparatus including a processor, a memory, an input and output apparatus, and a storage apparatus, the food authentication method comprising:
a first step of setting unique information of food measured at a first time as a unique information initial value;
a second step of acquiring environmental information that is associated with the food and that is measured at a second time after the first time;
a third step of setting unique information of the food measured at a third time after the second time as a unique information measurement value;
a fourth step of calculating a prediction value of the unique information based on the unique information initial value and the environmental information and setting the prediction value as a unique information prediction value; and
a fifth step of performing authentication of the food based on the unique information measurement value and the unique information prediction value.

2. The food authentication method according to claim 1, wherein
the unique information of the food is at least one selected from appearance, sugar content, acidity, alcohol content, odor, weight, hardness, a moisture amount, an odor component amount, a volatile component amount, and a contained component amount.

3. The food authentication method according to claim 1, wherein
the environmental information of the food is time series data.

4. The food authentication method according to claim 1, wherein
the environmental information of the food is data obtained from a sensor corresponding to the food.

5. The food authentication method according to claim 1, wherein
the environmental information of the food is at least one selected from temperature, humidity, a light amount, a gas concentration, and a vibration amount.

6. The food authentication method according to claim 1, wherein
the environmental information of the food reflects at least one state of storage and distribution associated with the food.

7. The food authentication method according to claim 1, wherein
there are a plurality of types of the unique information,
in the fourth step,
prediction values of the unique information are calculated based on a plurality of types of the unique information initial values and the environmental information and the prediction values are set as a plurality of types of the unique information prediction values, and
in the fifth step,
a principal component is extracted from a plurality of types of the unique information measurement values and reduced in dimensionality, a principal component is extracted from the plurality of types of the unique information prediction values and reduced in dimensionality, and authentication of the food is performed based on a distance between the principal components.

8. A food authentication system, comprising:
a processor;
a memory;
an input and output apparatus;
a storage apparatus;
a unique information prediction unit; and
an authentication unit, wherein
the unique information prediction unit is configured to:
receive unique information of food measured at a first time as a unique information initial value;
receive environmental information that is associated with the food and that is measured at a second time after the first time; and
calculate a prediction value of the unique information based on the unique information initial value and the environmental information, and set the prediction value as a unique information prediction value, and
the authentication unit is configured to:
receive unique information of the food measured at a third time after the second time as a unique information measurement value; and
perform authentication of the food based on the unique information measurement value and the unique information prediction value.

9. The food authentication system according to claim 8, wherein
the unique information of the food is at least one selected from appearance, sugar content, acidity, alcohol content, odor, weight, hardness, a moisture amount, an odor component amount, a volatile component amount, and a contained component amount.

10. The food authentication system according to claim 8, wherein
the environmental information of the food is time series data.

11. The food authentication system according to claim 8, wherein
the environmental information of the food is data obtained from a sensor corresponding to the food.

12. The food authentication system according to claim 8, wherein
the environmental information of the food is at least one selected from temperature, humidity, a light amount, a gas concentration, and a vibration amount.

13. The food authentication system according to claim 8, wherein
the environmental information of the food reflects at least one state of storage and distribution associated with the food.

14. The food authentication system according to claim 8, wherein
there are a plurality of types of the unique information,
the unique information prediction unit is configured to:
calculate prediction values of the unique information based on a plurality of types of the unique information initial values and the environmental information and set the prediction values as a plurality of types of the unique information prediction values, and
the authentication unit is configured to:
extract a principal component from a plurality of types of the unique information measurement values and reduce in dimensionality, extract a principal component from the plurality of types of the unique information prediction values and reduce in dimensionality, and perform authentication of the food based on a distance between the principal components.

15. The food authentication system according to claim 14, wherein
the distance is Euclidean distance.
